(19) United States
(12) Patent Application Publication
(10) Pub. No.: US 2007/0240062 A1
(43) Pub. Date: Oct. 11, 2007

(54) Method and System for Restricting User Operations in a Graphical User Inerface Window

(76) Inventors: Jennifer Y. Christena, Austin, TX (US); Johnathan A. Christena, Austin, TX (US); Brad R. Davis, Amarillo, TX (US); Brent D. Franklin, Round Rock, TX (US)

Correspondence Address: IBM CORPORATION;INTELLECTUAL PROPERTY LAW, 11400 BURNET ROAD, AUSTIN, TX, 78758, US

(21) Appl. No.: 11/278,989

(22) Filed: Apr. 7, 2006

(51) Int. Cl. G06F 3/00

(52) U.S. Cl. 715/741

(57) ABSTRACT

A method is presented for a GUI mechanism to restrict user input within a GUI window. A GUI control disablement function is activated by selecting a GUI control, which is dedicated to selecting enablement or disablement of the GUI control disablement function. When a user input event is received, the received user input event is discarded when the GUI control disablement function is in an activated state. At a granularity over an entire window, a user can select a GUI control that is associated with a GUI window, and the GUI control is not contained within the GUI window. The GUI window is then locked in response to selecting the GUI control such that subsequent user input for GUI controls within the GUI window cannot select those GUI controls.

### BACKGROUND OF THE INVENTION

1. Field of the Invention

The present invention relates to an improved data processing system and, in particular, to a method and apparatus for handling user operations within a graphical user interface that is displayed by a computer.

2. Description of Related Art

As desktop computers become more powerful, users employ the available computational power to require that more tasks are performed concurrently. Operating systems can accommodate multitasking applications, thereby allowing a user to accomplish more than one operation concurrently through multiple applications. Each of those applications may have one or more graphical user interface (GUI) windows that have been displayed on a user's desktop for accepting user input to control those applications.

Many applications, particularly multimedia applications, can process and/or transfer large amounts of data. These types of data-intensive operations may require relatively long periods of time to complete certain operations even though the user is employing a broadband communications link or high-speed network. A user may interact with multiple applications while waiting for a specific operation to complete in another application.

In some circumstances, a user's desktop can become cluttered with multiple GUI windows for multiple applications that are being used concurrently. While a user may be actively entering user input into one window, other windows may receive little user input or little user recognition while representing ongoing operations over long periods of time. On a cluttered desktop with multiple windows, if the user is careless, some of the user's actions that are intended for one window may be interpreted by the operating system as being directed to another window. The user must be careful to ensure that the appropriate window has the input focus so that the user's actions are properly entered into the intended window.

Although there are some GUI mechanisms that a user can employ to reduce the number of open windows that are displayed on a desktop, the user has relatively little control over the presentation of windows and the disappearance of windows.

Therefore, in order to minimize inadvertent user actions over multiple windows, it would be advantageous to offer to a user a GUI mechanism that allows the user to restrict the manner in which user input is accepted within a GUI window.

### SUMMARY OF THE INVENTION

A method, a system, an apparatus, and a computer program product is presented for providing a user with a GUI mechanism that allows the user to restrict the manner in which user input is accepted within a GUI window. A user can activate a GUI control disablement function by selecting a GUI control, which is dedicated to selecting enablement or disablement of the GUI control disablement function. When a user input event is received, the received user input event is discarded when the GUI control disablement function is in an activated state. When used at a granularity over an entire window, a user can select a GUI control that is associated with a GUI window, and the GUI control is not contained within the GUI window. The GUI window is then locked in response to selecting the GUI control such that subsequent user input with respect to GUI controls within the GUI window cannot select the GUI controls within the GUI window.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIGS. 2A-2B depicts a pair of diagrams that show typical graphical user interface (GUI) windows within a computer display;

FIG. 3 depicts a diagram that shows a GUI window that contains a user-selectable window control that disables other window controls;

FIG. 4 depicts a diagram that shows a GUI control disablement resource that is located graphically external to a GUI window that contains a GUI control that is enabled or disabled by manipulation of the GUI control disablement resource;

FIG. 5 depicts a block diagram that shows an organization of software functional elements and associated data for restricting GUI window operations;

FIG. 6 depicts a flowchart that shows a process for activating a GUI control disablement function;

FIG. 7 depicts a flowchart that shows a process for handling user input events by a GUI control disablement function;

FIG. 8 depicts a flowchart that shows a process for deactivating a GUI control disablement function;

FIG. 9 depicts a block diagram that shows an organization of software elements for managing a GUI disablement function external to an application program;

FIG. 10 depicts a diagram that shows a GUI window that contains multiple windows along with a GUI window disablement software agent;

FIG. 11 depicts a diagram that shows a dialog window for a GUI window disablement software agent; and

FIG. 12 depicts a block diagram that shows the data flow of user input events while employing an implementation of an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

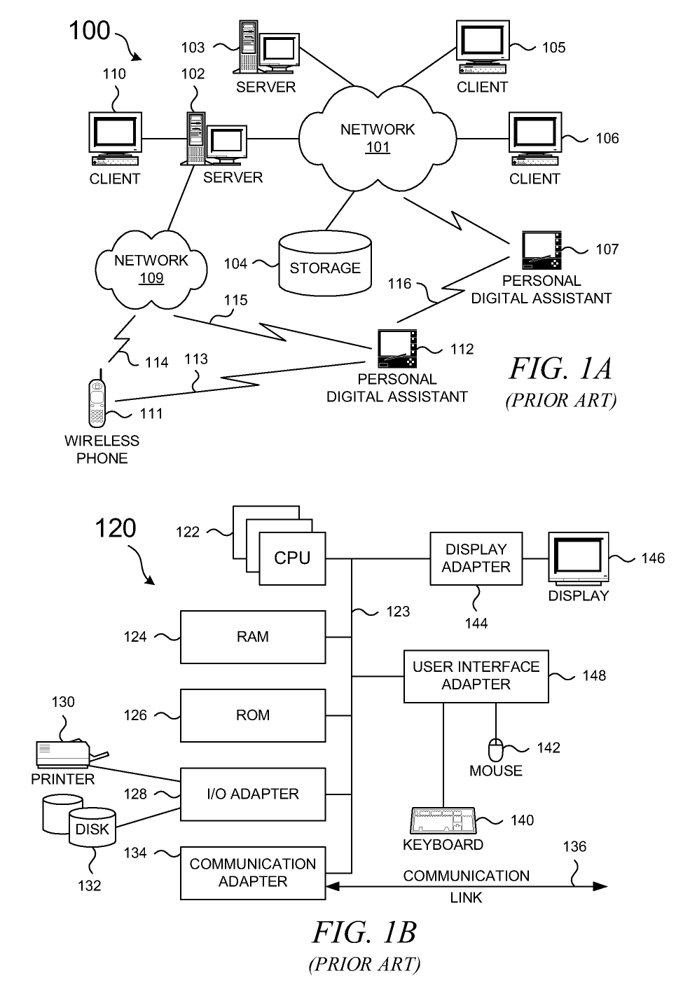

With reference now to the figures, FIG. 1A depicts a typical network of data processing systems, each of which may implement the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as LDAP (Lightweight Directory Access Protocol), TCP/IP (Transport Control Protocol/Internet Protocol), HTTP (HyperText Transport Protocol), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks or personal ad-hoc networks. In a similar manner, PDA 113 can transfer data to PDA 107 via wireless communication link 116.

The present invention could be implemented on a variety of hardware platforms and software environments. FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files. It should also be noted that the distributed data processing system shown in FIG. 1A is contemplated as being fully able to support a variety of peer-to-peer subnets and peer-to-peer services.

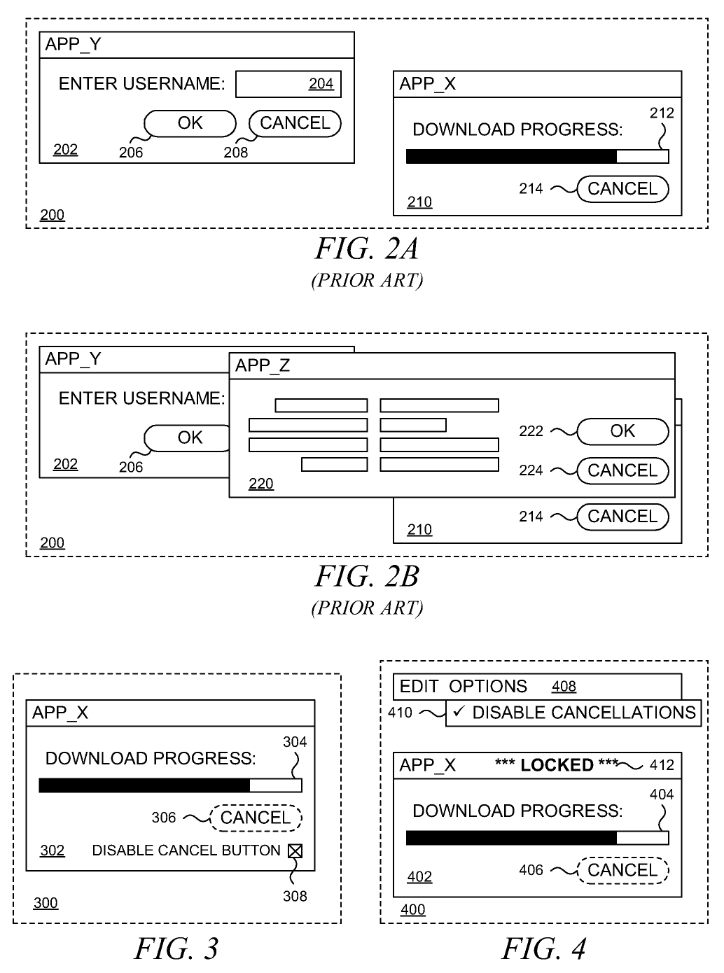

As mentioned above, typical operating systems can accommodate multitasking applications, thereby allowing a user to accomplish more than one operation concurrently through multiple applications. Each of those applications may have one or more graphical user interface (GUI) windows that have been displayed on a user's desktop for accepting user input to control those applications. A user may interact with multiple applications while waiting for a specific operation to complete in another application. In some circumstances, a user's desktop can become cluttered with multiple GUI windows for multiple applications that are being used concurrently, and if the user is careless, some of the user's actions that are intended for one window may be interpreted by the operating system as being directed to another window; this scenarios is illustrated in FIGS. 2A-2B as described hereinbelow.

With reference now to FIGS. 2A-2B, a pair of diagrams illustrate typical graphical user interface (GUI) windows within a computer display. FIG. 2A and FIG. 2B represent a portion of a GUI desktop on a computer display, such as display device 146 that is shown in FIG. 1B, wherein the GUI desktop changes over a period of time. FIG. 2A illustrates a desktop at a first point in time, and FIG. 2B illustrates the same desktop at a later point in time.

Referring to FIG. 2A, desktop 200 is a portion of a GUI desktop application that is typically controlled by the operating system within a computer. Window 202 is shown within desktop 200. Window 202 is associated with a first application and contains typical user input controls, such as text entry field 204, “OK” button 206, and “CANCEL” button 208. Window 210 is associated with a second application and contains a typical download progress control 212 and “CANCEL” button 214. Download progress control 212 is a bar-type control in which the bar increases in size as a download progresses over time; download progress control 212 is unmodifiable or unselectable by the user. However, button 214 could be selected by a user to cancel the download in progress, e.g., by clicking on a mouse button while a mouse cursor on the display is hovering over the displayed button.

Referring to FIG. 2B, desktop 200 is shown again at a later point in time compared to FIG. 2A; window 202 and window 210 are still displayed within desktop 200. However, portions of windows 202 and 210 have become obscured by window 220, which contains its own text information and user-selectable controls, such “OK” button 222 and “CANCEL” button 224.

As a user is manipulating and using windows 202, 210, and 220 within desktop 200, the user needs to be careful to direct input operations to the window that has the input focus, which is usually the window that is displayed on top of the other windows. However, the user may inadvertently change the input focus from one window to another window, after which another user action is interpreted as being entered within the other window. In addition, in some systems, a user is able to select a user control within a window without a prior change in the input focus; in other words, the user action in the other window acts to select the other window for the input focus and also to select a control within the other window. In any case, within any desktop, especially within a cluttered desktop in which a busy user is interacting with multiple applications over a period of time, a user may perform an undesired action within a GUI control that cannot be corrected or undone.

For example, in FIG. 2B, there may be a scenario in which a user might desire to hit the “Enter” key on the computer keyboard, thereby selecting “OK” button 222 in window 220. However, prior to hitting the “Enter” key, the user inadvertently selects window 210 through a mouse operation; since window 210 does not have any other selectable controls, the hitting of the “Enter” key is interpreted as a selection of “CANCEL” button 214. In this case, if the application does not require a confirmation of the cancellation request, then the user would inadvertently request an operation within the wrong application with an unintended result.

As mentioned above, in some systems, a user is able to select a user control, such as button 214 within window 210, even though window 220 has the input focus, thereby switching the focus between windows and selecting a GUI control with the same user input action. In the example that is shown in FIG. 2B, a user might decide to select “CANCEL” button 224 in window 220, but because the user is not attentive or only glances at desktop 200, the user selects “CANCEL” button 214 instead. Rather than canceling an operation with respect to one application, the user unintentionally cancels an operation with respect to another application.

Moreover, in the example that is shown in FIG. 2B, if the user inadvertently selects “CANCEL” button 214 rather than “CANCEL” button 224, the user cancels a file download operation. If the file that is being downloaded is a digital movie or some other type of very large data file, then the complete download operation might require hours, even over a broadband communication link. If the user inadvertently cancels the download operation after a significant portion of the file has been downloaded, then hours of waiting are wasted by the user's mistake. In a other software environments, application programs may execute for many hours; unintentional interruption or cancellation of these types of computational jobs may be significantly costly. Although such user errors can be minimized by employing well-known, user-friendly, GUI techniques, such as the presentation of a dialog box to the user to confirm a cancellation operation, similar errors can occur with respect to these additional windows, such as inadvertent closure.

The present invention is directed to providing solutions to such problems in order to prevent user errors within a GUI environment from causing unintended consequences. The present invention provides a user with a GUI mechanism that allows the user to restrict the manner in which user input is accepted within a GUI window, as described in more detail hereinbelow and as illustrated with respect to the remaining figures.

With reference now to FIG. 3, a diagram illustrates a GUI window that contains a user-selectable window control that disables other window controls in accordance with an embodiment of the present invention. Desktop 300 is a portion of a GUI desktop application that is controlled by the operating system within a computer. Window 302 is associated with an application program and is shown within desktop 300. In a manner similar to window 210 that is shown in FIG. 2A, window 302 contains download progress control 304 and “CANCEL” button 306.

In accordance with an embodiment of the present invention, window 302 contains a user-selectable window control that disables another window control within the same window. In this example, checkbox 308 is a user-selectable window control that is associated with button 306 and is used to configure the enablement or the disablement of button 306 within window 302. Checkbox 308 is associated with a text label that reads: “DISABLE CANCEL BUTTON”; the selection of checkbox 308 determines whether or not “CANCEL” button 306 is disabled. In this example, checkbox 308 has been selected by a user, as shown by the check mark within checkbox 308; in response, “CANCEL” button 306 has been disabled, as shown by the non-solid line for the outline of button 306. Button 306 could become enabled at some later point in time when a user again selects checkbox 308 and removes the check mark within checkbox 308.

In the exemplary embodiment of the present invention that is shown in FIG. 3, a user is able to assert a restriction on the ability of a GUI window to accept user input; in other words, a user is able to assert a restriction on the user's own ability to enter user input into a GUI window. In this example, the user can restrict the user's own ability to use a button in a GUI window through another GUI control within the GUI window. As shown in FIG. 3, the checkbox must be deselected if already selected in order to select the “CANCEL” button.

In contrast to a confirmation dialog box that appears after selecting a “CANCEL” button, the checkbox acts as a type of confirmation of the user's intention to select the “CANCEL” button before the user selects the “CANCEL” button. In this manner, the present invention requires a user action on a first GUI control before another user action on a second GUI control. Hence, the present invention uses a GUI control in order to confirm an operation on another GUI control.

The type of scenario that was described with respect to FIG. 2B cannot occur in the exemplary window that is shown in FIG. 3. After the user has disabled the “CANCEL” button, the user would be required to inadvertently select the checkbox and then inadvertently select the “CANCEL” button in order to inadvertently cancel the download operation that is in progress. Although it is possible for a user to inadvertently perform two GUI operations that have an unintended consequence, the present invention provides a GUI mechanism for minimizing significant unintended computational costs that are caused by user errors.

It should be noted that, in different embodiments, operations on the pairing of a checkbox in a GUI window to control a button in a GUI window may be performed in various ways. For example, the checkbox could be configured to be already selected by default when its window is initially displayed, thereby initially disabling a “CANCEL” button that is associated with the checkbox.

In addition, it should be noted that an implementation of the present invention is not limited to an association of a checkbox and a button and that the type of GUI controls that are employed in an implementation of the present invention may vary. More broadly, an implementation of the present invention may employ an association of a first GUI control with a second GUI control; a first GUI control acts as a GUI control disablement resource with respect to a second GUI control resource, thereby allowing the user to restrict the manner in which user input is accepted within a GUI window. FIG. 4 illustrates a different implementation of an embodiment of the present invention using a GUI resource other than a checkbox as the GUI control disablement resource.

With reference now to FIG. 4, a diagram illustrates a GUI control disablement resource that is located graphically external to a GUI window that contains a GUI control that is enabled or disabled by manipulation of the GUI control disablement resource in accordance with an embodiment of the present invention. In contrast to the example that is shown in FIG. 3, a GUI menu mechanism acts as a GUI control disablement resource that enables or disables a GUI control within a GUI window.

Desktop 400 is a portion of a GUI desktop application that is controlled by the operating system within a computer. Window 402 is associated with an application program and is shown within desktop 400. In a manner similar to window 302 that is shown in FIG. 3, window 402 contains download progress control 404 and “CANCEL” button 406.

In the example that is shown in FIG. 4, menu bar 408 contains menu item/sub-menu 410 that toggles between two values, i.e. a selected state and a deselected state. Upon selection of menu item 410 by a user, a check mark appears next to menu item 410 to show that it has been selected; upon a subsequent selection or re-selection by the user, menu item 410 becomes deselected, and the check mark disappears.

In this example, the selection of a GUI control disablement resource, i.e. menu item 410, by the user disables the user's ability to select “CANCEL” button 406. When the user attempts to select “CANCEL” button 406 by clicking on button 406 using a user input device, e.g., a mouse, the user is not able to activate button 406, and those particular user events that are directed to button 406 are discarded while menu item 410 is in a selected state.

In a one implementation, menu item 410 may be associated with one particular button or GUI control resource, such as button 406 within a particular window; in this implementation, the selection of menu item 410 does not affect any other GUI control. Alternatively, the selection of menu item 410 affects all GUI controls within a given window, thereby disabling all user input to the given window; in this case, the affected window could be graphically indicated in some manner, such as text string 412 within the title bar of window 402. The given window that is associated with menu item 410 could be predetermined or preconfigured, or the given window might be implicitly chosen by the user as being the window that currently has the input focus, e.g., the topmost displayed window, when menu item 410 is selected by the user.

In another alternative embodiment, the selection of menu item 410 may affect a certain class of GUI controls, e.g., all “CANCEL” buttons that appear within any window that is controlled by the application program. The class of GUI controls that are associated with menu item 410 may be selectable by the user or may be predetermined or preconfigured, e.g., hard-coded within the application program or specified in a configurable way through a resource file.

In yet another alternative implementation, the selection of menu item 410 may affect a group of predetermined or preconfigured GUI control resources, such as a set of GUI controls that are known to be potentially problematic with respect to their ability to accept or to cause user errors and, therefore, their ability to cause unintended consequences that are computationally costly.

In the embodiment of the present invention that is shown in FIG. 4, the selection of a GUI control disablement resource by the user may be viewed as activating a window disablement function. While the GUI control disablement resource remains in a selected state, certain GUI control resources are disabled. More broadly, while the GUI control disablement resource remains in a selected state, a user asserts a restriction on the user's own ability to enter user input into a GUI window. More specifically, while the GUI control disablement resource remains in a selected state, a user is not able to select or operate one or more GUI controls within one or more GUI windows; when a user attempts to operate those GUI controls, particular user input events within a GUI window with respect to those GUI controls are discarded.

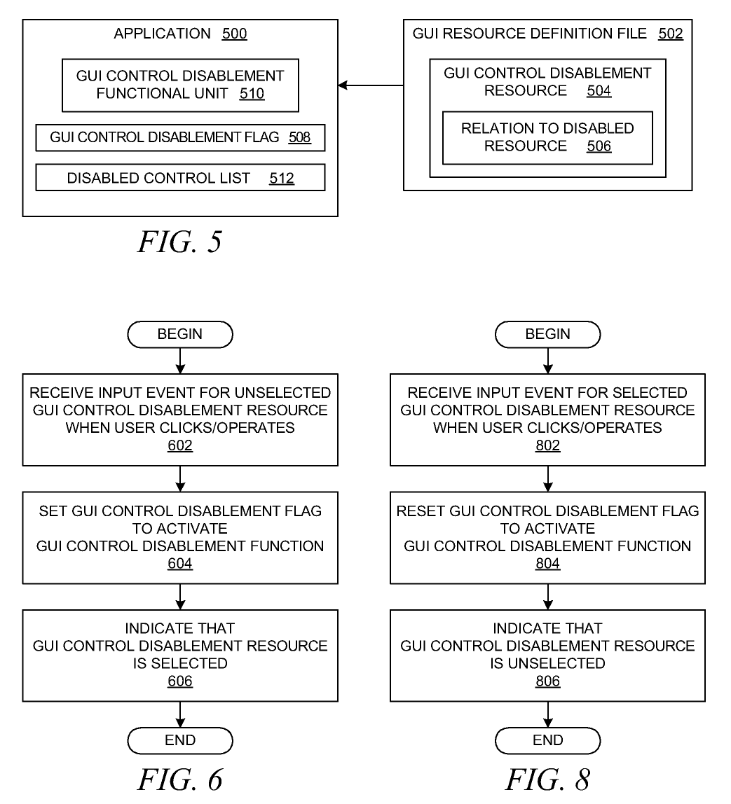

With reference now to FIG. 5, a block diagram illustrates an organization of software functional elements and associated data for restricting GUI window operations in accordance an embodiment of the present invention. FIG. 5 illustrates an example of a generalized mechanism for an embodiment of the present invention by which a GUI control disablement resource, such as checkbox 308 in FIG. 3 or menu item 410 in FIG. 4, is used to restrict user input within a GUI window.

Application 500 represents an application program that may perform a variety of tasks through interaction with a user via a graphical user interface. As is typical in many software execution environments, application 500 reads resource definition file 502, which contains definitions of resources or properties that guide the runtime behavior of application 500. Resource file 502 is typically read by application program 500 during an initialization phase, but resource file 502 may also be accessed during runtime. Resource file 502 contains information and runtime values of user interactive controls that are presented within the GUI windows that are used by application 500 during each of its execution sessions. By placing the resource information into a configurable file, the resource information is separated from the application code, and any changes to the resource information can be made without having to re-compile the application code.

In an exemplary embodiment of the present invention, resource file 502 contains a definition for GUI control disablement resource 504, such as checkbox 308 in FIG. 3 or menu item 410 in FIG. 4. GUI control disablement resource 504 may also contain a link, an association, or some other type of relation information 506 with the GUI resource that it disables, such as button 306 in FIG. 3 or button 406 in FIG. 4.

During runtime, a user may select the GUI control disablement resource, and application program 502 stores this fact by setting GUI control disablement flag 508; while flag 508 is set, a given GUI control is disabled, thereby preventing the user from inadvertently selecting the given GUI control. At some other point in time during the runtime phase, the user may deselect the GUI control disablement resource, and application program 502 stores this fact by resetting or clearing GUI control disablement flag 508; while flag 508 is cleared, a given GUI control is enabled, thereby allowing the user to select, either inadvertently or explicitly, the given GUI control. In most circumstances, the user would deselect the GUI control disablement resource at a point in time shortly before the user desires to select the given GUI control, thereby explicitly performing certain user actions so that inadvertent user errors do not occur with respect to the user's input operations.

Application program 500 contains GUI control disablement functional unit 510, which manages GUI control disablement flag 508. GUI control disablement functional unit 510 performs determinations on whether or not user input operations with respect to enabled or disabled GUI control resources should be allowed or disallowed, i.e. discarded. In other words, in a preferred embodiment, any code that handles the functionality of the present invention would be contained within GUI control disablement functional unit 510.

As noted above, in certain embodiments, the association between a GUI control disablement resource, such as menu item 410 in FIG. 4, and the specific GUI control or the specific GUI window, i.e. the one that becomes disabled, is preconfigured or predetermined. However, in other embodiments, the user may dynamically create the association through certain user actions; for example, as mentioned above, the given window might be implicitly chosen by the user as being the window that currently has the input focus, e.g., the topmost displayed window. Hence, GUI control disablement functional unit 510 manages disabled control list 512, which contains information about the specific GUI control/controls and/or GUI window/windows that is/are disabled by one or more GUI control disablement resource/resources. When certain user input actions occur with respect to GUI objects within disabled control list 512, GUI control disablement functional unit 510 processes the input events and determines the appropriate outcomes.

With reference now to FIG. 6, a flowchart illustrates a process for activating a GUI control disablement function in accordance with an embodiment of the present invention. The process that is shown in FIG. 6 is a generalization of the manner in which a user could select a checkbox, as in FIG. 3, or could select a menu item, as in FIG. 4, to restrict user input operations.

The process commences upon receiving a user input event on an unselected GUI control disablement resource, i.e. when a user clicks or operates a specific GUI control resource that subsequent restricts user input (step 602). A GUI control disablement flag is set to reflect the fact that a GUI control disablement function is now activated (step 604). A displayed window is then changed or modified in some manner to reflect that the GUI control disablement resource is now selected (step 606), and the process is concluded.

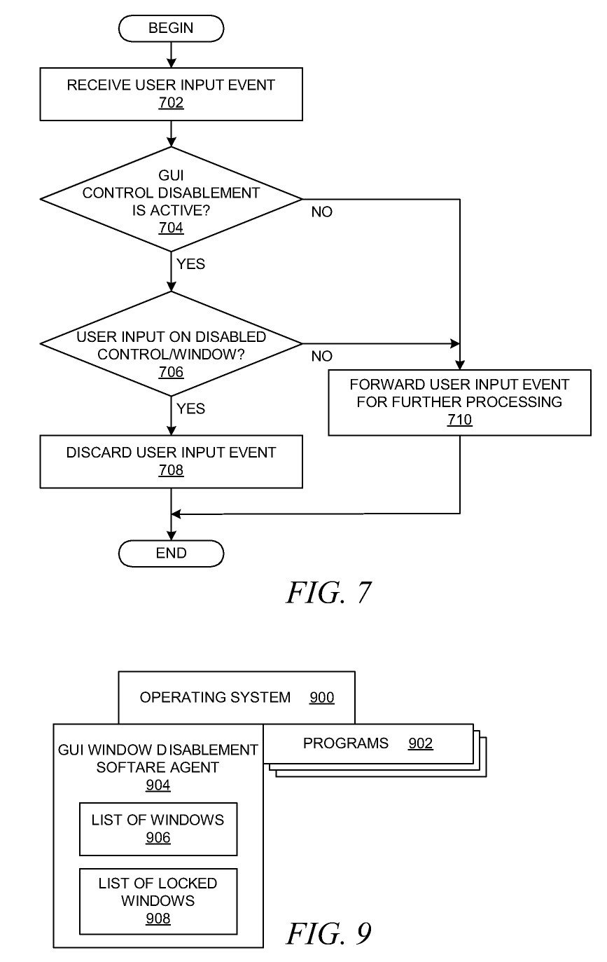

With reference now to FIG. 7, a flowchart illustrates a process for handling user input events by a GUI control disablement function in accordance with an embodiment of the present invention. The process commences when a user input event is received (step 702), which is generated in response to a user action or operation with respect to a graphical user interface. A determination is then made as to whether or not a GUI control disablement function has been previously activated (step 704), e.g., by checking the state of a processing flag. If so, then a determination is made as to whether or not the user input event was on a disabled control resource or a disabled window (step 706), e.g., by checking a dynamically generated, internal list of such resources and windows. If the user input event is within the disabled control resource or within a disabled window, then the user input event is discarded (step 708), and the process is concluded. If the user input event is not within the disabled control resource or within a disabled window, as determined at step 706, or if the GUI control disablement function is not activated, as determined at step 704, then the user input event is forwarded for further processing (step 710), and the process is concluded.

With reference now to FIG. 8, a flowchart illustrates a process for deactivating a GUI control disablement function in accordance with an embodiment of the present invention. The process that is shown in FIG. 8 is a generalization of the manner in which a user could deselect a checkbox, as in FIG. 3, or could deselect a menu item, as in FIG. 4, to release a restriction on user input operations; hence, the process that is shown in FIG. 8 is the complement of the process that is shown in FIG. 6.

The process commences upon receiving a user input event on a selected GUI control disablement resource, i.e. when a user clicks or operates a specific GUI control resource that subsequent unrestricts user input (step 802). A GUI control disablement flag is cleared or reset to reflect the fact that a GUI control disablement function is now deactivated (step 804). A displayed window is then changed or modified in some manner to reflect that the GUI control disablement resource is now unselected (step 806), and the process is concluded.

With reference now to FIG. 9, a block diagram illustrates an organization of software elements for managing a GUI disablement function external to an application program in accordance with an implementation of an embodiment of the present invention. Operating system 900 provides system calls and computational support for programs 902 and other software elements, such as software agent 904.

In contrast to the previously described figures in which management of user disablement of GUI objects was performed by the application programs that created the GUI objects, GUI window disablement software agent 904 is a program that manages the disablement or locking of GUI windows that belong to other programs, especially application programs. Whereas other embodiments of the present invention as described hereinabove can be implemented to control user input restrictions on individual GUI controls within GUI windows, embodiments of the present invention as described hereinbelow may be implemented to control user input restrictions on GUI windows as a whole.

Hence, the process by which GUI window disablement software agent 904 performs its functionality is very similar to what is shown in within FIG. 7. Input events are received, analyzed, and depending upon the intended target, are possibly discarded or otherwise ignored.

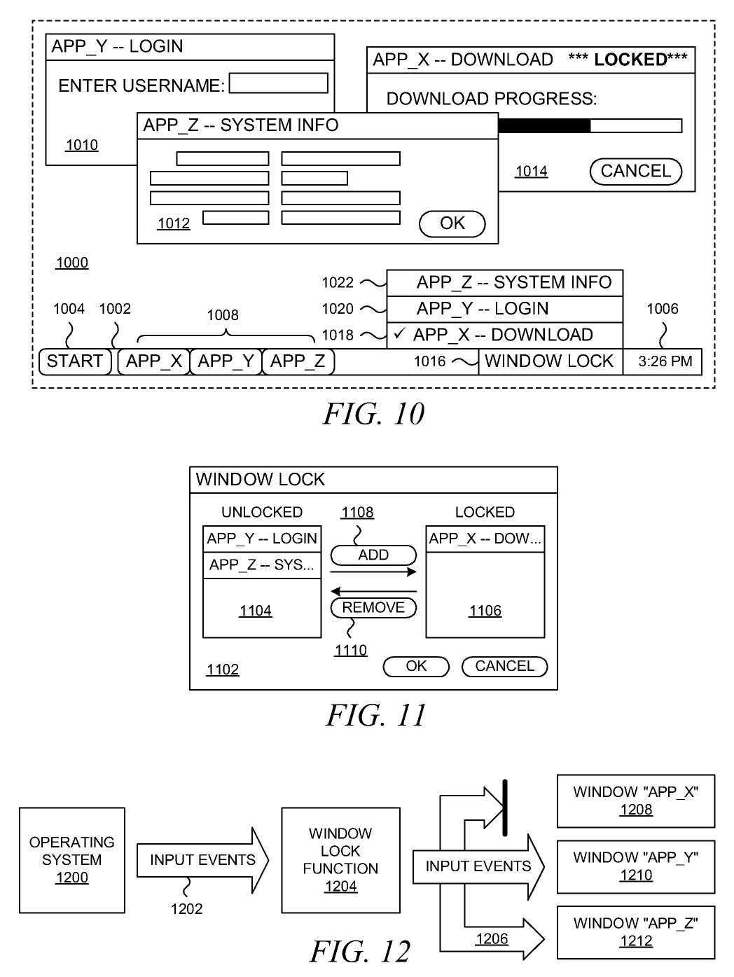

The organization of software elements that support the functionality of GUI window disablement software agent 904 may very, but an exemplary embodiment is shown in FIG. 9. Software agent 904 registers with operating system 900 to receive notification of certain GUI events. When windows are created or destroyed by application programs, software agent 904 receives a notification event and maintains list 906 of active windows. Alternatively, software agent 904 requests or retrieves list 906 from operating system 900, e.g., by reading a data structure that is maintained by operation system 900 or by a system call to operating system 900. As certain windows become locked/disabled as requested by a user, software agent 904 maintains list 908 of locked/disabled windows. In this manner, software agent 904 assumes a role that is analogous to GUI control disablement functional unit 510 that is shown in FIG. 5. It should be noted, however, that the functionality of software agent 904 could be embodied in certain application programs or embedded within the operating system itself. Moreover, the GUI format in which software agent 904 is presented may vary with different implementations and depending upon whether or not software agent 904 is implemented as a stand-alone program, an operating system utility, or some other format, as illustrated with respect to FIG. 10 and FIG. 11.

With reference now to FIG. 10, a diagram illustrates a GUI window that contains multiple windows along with a GUI window disablement software agent in accordance with an embodiment of the present invention. Desktop 1000 is a portion of a GUI desktop application that is controlled by the operating system within a computer. Task bar 1002 contains start menu 1004, clock display 1006, and application tabs 1008 with corresponding application windows 1010-1014.

A GUI window disablement software agent is presented within desktop 1000 by being shown in task bar 1002 as application tab 1016 with the name “Window Lock”. When application tab 1016 is selected, e.g., by clicking on it and holding it open, a vertical menu appears with menu items 1018-1022, which forms a list of the windows that are currently open within desktop 1000. When a user scrolls to one of the menu items, its state is toggled between selected and unselected, thereby locking/disabling or unlocking/enabling, respectively, the application window that is associated with that menu item. In the example that is shown in FIG. 10, menu item 1018 is indicated as having been selected by placing a check mark within the menu item; associated window 1014 is indicated as being locked/disabled, i.e. unable to accept user input, by modifying the title bar of window 1014 to indicate this special status.

With reference now to FIG. 11, a diagram illustrates a dialog window for a GUI window disablement software agent in accordance with an implementation of an embodiment of the present invention. The example of a set of applications that is shown in FIG. 11 is similar to the example that is shown in FIG. 10.

Dialog window 1102 allows a user to interact with the GUI window disablement software agent in order to choose one or more application windows that the user desires to lock or to disable. Dialog window 1102 displays list 1104 of the names of enabled/unlocked application windows and list 1106 of the names of disabled/locked application windows. The name of an application window within list 1104 can be selected by the user, who then clicks “ADD” button 1108; in response, the GUI window disablement software agent disables/locks the selected application window, and the name of the selected application window is removed from list 1104 and added to list 1106. The user is subsequently unable to enter user input into the newly locked/disabled application window, including mouse clicks, text entry, or other input.

Similarly, the name of an application window within list 1106 can be selected by the user, who then clicks “REMOVE” button 1110; in response, the GUI window disablement software agent enables/unlocks the selected application window, and the name of the selected application window is removed from list 1106 and added to list 1104. The user is subsequently able to enter user input into the newly unlocked/enabled application window, including mouse clicks, text entry, or other input.

With reference now to FIG. 12, a block diagram illustrates the data flow of user input events while employing an implementation of an embodiment of the present invention. FIG. 12 shows the results of allowing a user to restrict user input into application windows via a GUI window disablement software agent. As operating system 1200 generates software input events 1202 in response to hardware input events, such as mouse clicks and keyboard key hits, it sends the input events to the appropriate applications. With an embodiment of the present invention, a window lock function 1204, such as would be contained within a GUI window disablement software agent, registers itself through a system call with operating system 1200 to receive and filter those input events 1202. Some of input events 1202 are forwarded as input events 1206 to applications that are associated with windows 1208-1212. If the window lock function determines that a user input event 1202 is directed at a window that has been locked or disabled by the user, e.g., through the GUI mechanisms that are illustrated in FIG. 10 or FIG. 11, some of the input events are discarded so that they are not received by an application program and cannot thereafter be processed to have an effect on a specific window.

The advantages of the present invention should be apparent in view of the detailed description of the invention that is provided above.

Various embodiments of the present invention provide GUI mechanisms for a user to disable or lock a control within a GUI window or an entire GUI window. The user is able to use the provided GUI mechanisms to toggle between locked/disabled and unlocked/enabled states on the targeted GUI controls and/or GUI windows. Using the present invention, the user is able to minimize inadvertent user input errors that may cause consequential computational costs.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for processing user input within a graphical user interface (GUI) of a computer, the computer-implemented method comprising:
selecting a GUI control that is associated with a GUI window in response to receiving user input with respect to the GUI control, wherein the GUI control is not contained within the GUI window; and
locking the GUI window in response to selecting the GUI control such that subsequent user input with respect to GUI controls within the GUI window cannot select the GUI controls within the GUI window.

2. The method of claim 1 further comprising:
discarding subsequent user input with respect to GUI controls within the GUI window in response to determining that the GUI window is locked.

3. The method of claim 1 further comprising:
unselecting the GUI control; and
unlocking the GUI window.

4. The method of claim 1 further comprising:
managing selection of the GUI control within an application program.

5. The method of claim 1 further comprising:
associating management of the GUI window with a first program; and
managing selection of the GUI control within a second program.

6. The method of claim 5 further comprising:
filtering user input by the second program prior to notifying the first program about the user input.

7. The method of claim 5 further comprising:
discarding, by the second program, user input within the GUI window while the GUI window is locked.

8. A computer program product on a computer readable storage medium for use in a data processing system for processing user input within a graphical user interface (GUI) of a computer, the computer program product comprising:
means for selecting a GUI control that is associated with a GUI window in response to receiving user input with respect to the GUI control, wherein the GUI control is not contained within the GUI window; and
means for locking the GUI window in response to selecting the GUI control such that subsequent user input with respect to GUI controls within the GUI window cannot select the GUI controls within the GUI window.

9. The computer program product of claim 8 further comprising:
means for discarding subsequent user input with respect to GUI controls within the GUI window in response to determining that the GUI window is locked.

10. The computer program product of claim 8 further comprising:
means for unselecting the GUI control; and
means for unlocking the GUI window.

11. The computer program product of claim 8 further comprising:
means for managing selection of the GUI control within an application program.

12. The computer program product of claim 8 further comprising:
means for associating management of the GUI window with a first program; and
means for managing selection of the GUI control within a second program.

13. The computer program product of claim 12 further comprising:
means for filtering user input by the second program prior to notifying the first program about the user input.

14. The computer program product of claim 12 further comprising:
means for discarding, by the second program, user input within the GUI window while the GUI window is locked.

15. A computer program product on a computer readable storage medium for use in a data processing system for processing user input within a graphical user interface (GUI) of a computer, the computer program product comprising:
means for selecting a GUI control that is associated with a GUI window in response to receiving user input with respect to the GUI control, wherein the GUI control is not contained within the GUI window; and
means for locking the GUI window in response to selecting the GUI control such that subsequent user input with respect to GUI controls within the GUI window cannot select the GUI controls within the GUI window.

16. The computer program product of claim 15 further comprising:
means for discarding subsequent user input with respect to GUI controls within the GUI window in response to determining that the GUI window is locked.

17. The computer program product of claim 15 further comprising:
means for unselecting the GUI control; and
means for unlocking the GUI window.

18. The computer program product of claim 15 further comprising:
means for managing selection of the GUI control within an application program.

19. The computer program product of claim 15 further comprising:
means for associating management of the GUI window with a first program; and
means for managing selection of the GUI control within a second program.

20. The computer program product of claim 19 further comprising:
means for filtering user input by the second program prior to notifying the first program about the user input.
